(19) United States
(12) Patent Application Publication
(10) Pub. No.: US 2026/0042531 A1
(43) Pub. Date: Feb. 12, 2026

(54) METHODS AND APPARATUS FOR WING DEPLOYMENT IN AIR LAUNCHED EFFECTS SYSTEMS

(71) Applicant: The Boeing Company, Arlington, VA (US)

(72) Inventors: Alexander Andryukov, Gainesville, VA (US); Jacob Voelckers, Manassas, VA (US); Nathaniel Warfield, Bristow, VA (US); Kurt T. Wagner, Centreville, VA (US); Ridge A. Sibold, Washington, DC (US)

(21) Appl. No.: 18/798,291

(22) Filed: Aug. 8, 2024

(51) Int. Cl. B64C 3/56; B64F 5/10; B64U 70/20; B64U 101/00

(52) U.S. Cl. CPC B64C 3/56; B64U 70/20; B64U 2101/00

(57) ABSTRACT

Methods and apparatus for wing deployment in air launched effects systems are disclosed. A disclosed apparatus for deploying a wing for an aircraft includes a rotational joint at a fuselage of the aircraft, a spring having a first end and a second end, and a hub defined by or operatively coupled to the wing, the hub operatively coupled to the first end of the spring, the second end of the spring operatively coupled to the fuselage, the spring to urge the wing to move relative to the fuselage when the aircraft is launched from a host.

### FIELD OF THE DISCLOSURE

This disclosure relates generally to aircraft and, more particularly, to methods and apparatus for wing deployment in air launched effects systems.

### BACKGROUND

Air launched effects (ALE) systems employ a mechanical system to enable folded control surfaces to deploy after launch from a host in a fixed size circular or square tube form factor. In particular, the control surfaces are sized according to span, chord and airfoil, mass, inertia, strength, and stiffness to satisfy the gross take-off weight (GTOW) requirements, center-of-gravity (CG) requirements, as well as launch tube requirements.

Known ALE vehicle implementations utilize swinging wings on a pivot or pivots, with an optional augmentation in wing area after deployment. This can be accomplished through a spanwise extension or a change in chord length via a hinged trailing edge. In a particular known implementation, trailing edge augmentation is implemented with a pair of wings on angled, independent pivots. Accordingly, deployment of the wing is actuated by pushrods, crank arms, a central lever and a single gas spring or an extension servo.

### SUMMARY

An example apparatus for deploying a wing for an aircraft includes a rotational joint at a fuselage of the aircraft, a spring having a first end and a second end, and a hub defined by or operatively coupled to the wing, the hub operatively coupled to the first end of the spring, the second end of the spring operatively coupled to the fuselage, the spring to urge the wing to move relative to the fuselage when the aircraft is launched from a host.

An example wing assembly for use with an aircraft includes a wing having a slot, a spring at least partially disposed in the slot, and a hub of the wing, the hub to be rotatably coupled to a rotational joint of a fuselage of the aircraft, the spring operatively coupled between the hub and the fuselage to urge the wing to rotate for deployment thereof.

An example method of producing an aircraft with a deployable wing includes placing at least a portion of a spring in a recess of a hub of the wing, operatively coupling the hub of the wing to a rotational joint of a fuselage of the aircraft, and operatively coupling the spring between the hub and the fuselage to urge the wing to move relative to the fuselage when the aircraft is launched from a host.

### BRIEF DESCRIPTION OF THE DRAWINGS

FIG. 1 is an example aircraft launch system in which examples disclosed herein can be implemented.

FIG. 2 depicts folding of the example aircraft of FIG. 1.

FIG. 3 is an exploded view of an example folding apparatus in accordance with teachings of this disclosure.

FIG. 4 is a flowchart of an example method to produce examples disclosed herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

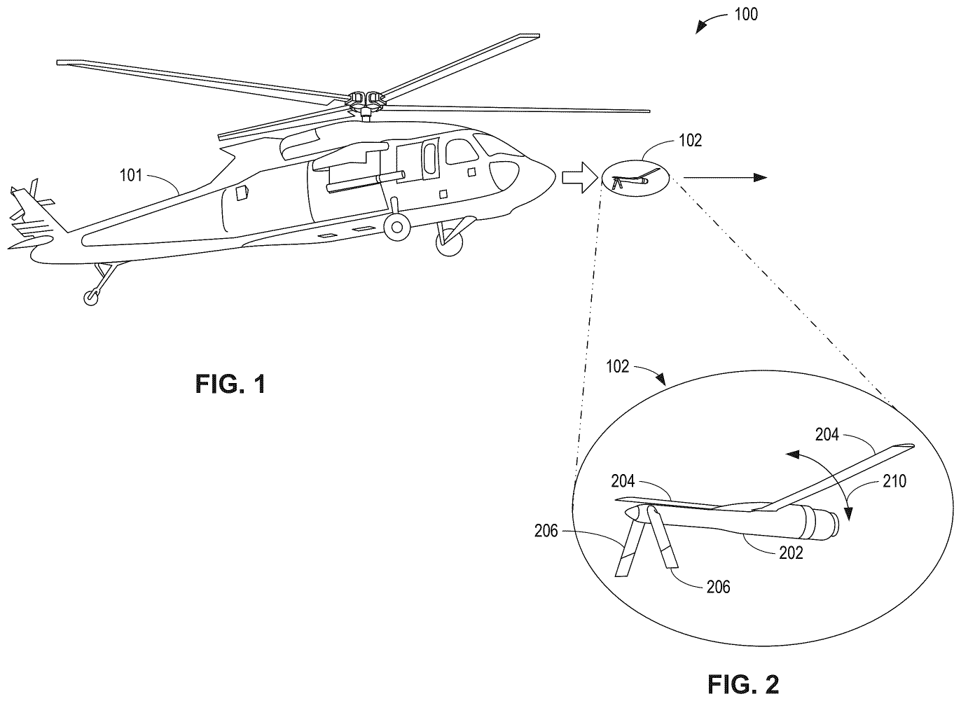

FIG. 1 is an example aircraft launch system 100 in which examples disclosed herein can be implemented. In particular, FIG. 1 depicts an aircraft launched effects (ALE) implementation in which an aircraft 102 is launched from a host 101, which is also implemented as an aircraft in this example. In other examples, the host 101 may be a ground-based vehicle, an unmanned aerial vehicle (UAV), a stationary launcher, a ground-based launcher, a water-bound launcher, a maritime launcher, etc. In this particular example, the aircraft 102 is launched from the host 101 while the host 101 moves and/or is being controlled/piloted.

According to examples disclosed herein, the aircraft 102 is launched and/or deployed from the host 101 in a folded/stowed state generally resembling the shape of a cylinder or other elongate structure, for example.

Accordingly, subsequent to the aircraft 102 being launched in the folded/stowed state, components and/or aerodynamic surfaces of the aircraft 102 are unfolded and/or moved outward relative to external surfaces of the aircraft 102. As will be discussed below in connection with FIGS. 2-4, examples disclosed herein deploy and/or unfold at least one wing and/or wing portion of an aircraft with lightweight components, thereby reducing and/or eliminating a need for disadvantageously heavier devices/equipment, such as actuators or motors, that can necessitate significant volume as well, which volume could otherwise be dedicated to other purposes, such as to store more and/or larger payloads. Further, in known implementations, actuators or servos are relied upon for maintaining a position and/or orientation of control surfaces, thereby necessitating stronger (and heavier) components to reduce a probability of potential damage and/or improper control, also disadvantageously adding weight plus reducing available space within the aircraft, e.g., for more and/or larger payload.

FIG. 2 depicts the example aircraft 102 of FIG. 1. The aircraft 102 is an unmanned aerial vehicle (UAV) in a foldable fixed wing implementation. The example aircraft 102 is foldable for storage/stowage and can expand and/or unfold in response to being launched and/or released from the host 101 shown in FIG. 1. In the illustrated example of FIG. 2, the aircraft 102 includes a fuselage 202 with wings 204 and a tail 206 extending therefrom.

In this example, at least one of the wings 204 folds in an outward direction relative to the fuselage 202 when the aircraft 102 is launched (e.g., in an ALE implementation). In particular, motion of the aircraft 102 during flight and spring-based devices/mechanisms cause the wing 204 to unfold. In other words, the wing 204 can be passively deployed, thereby reducing weight and volume usage, which can be particularly advantageous for aircraft. In some examples, a flow of air past the wing 204 facilities and/or causes unfolding thereof. In particular, the wing 204 can be rotated inward/outward, as generally indicated by a double arrow 210. Examples disclosed herein utilize springs to unfold aerodynamic surfaces, such as wings, stabilizers or tails, relative to the fuselage 202. While the example of FIG. 2 includes a foldable wing mechanism, other examples may correspond to other rotatable components and/or sections of a vehicle.

While examples disclosed herein are shown and described in the context of unmanned aircraft, examples disclosed herein can be implemented in vehicles, manned aircraft, non-fixed wing aircraft, watercraft, submersibles, spacecraft, ground-based vehicles, etc.

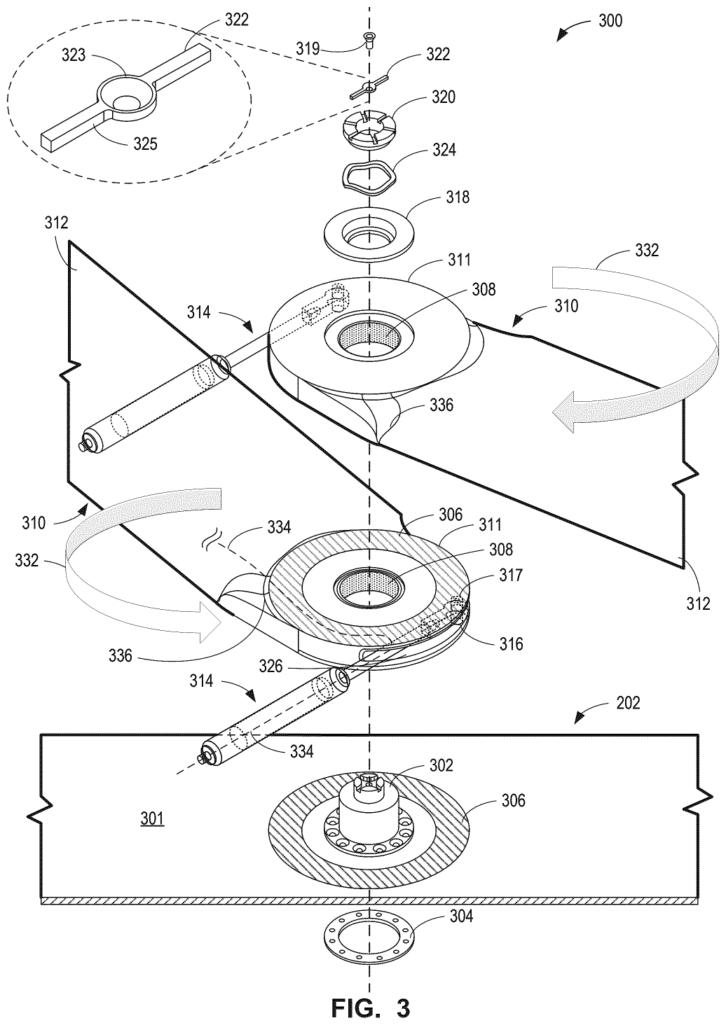

FIG. 3 is an exploded view of an example folding apparatus (e.g., a wing assembly) 300 in accordance with teachings of this disclosure. In this example, the folding apparatus 300 is assembled to and/or positioned on a surface (e.g., an exterior surface, a skin surface, etc.) 301 of the fuselage 202. According to examples disclosed herein, the folding apparatus 300 includes a rotational joint (e.g., a spindle, a wing spindle, a keyed joint, a rotational joint, a spindle joint, etc.) 302, a fitting (e.g., a spindle attachment fitting, an interior fitting, etc.) 304, anti-friction shims 306, sleeve bearings 308, wings 310, each of which includes a corresponding rotational joint/hub (e.g., a wing root, a proximal wing hub, etc.) 311 and a wing surface 312, springs (e.g., gas compression springs, fluid dampers, shocks, suspension elements, spring elements, etc.) 314, each of which includes an eye (e.g., rod eye, a rod end, etc.) 316 and a bushing 317, a fastener (e.g., a screw, a flat head screw, etc.) 319, a retainer (e.g., a retention washer) 318, a fastener (e.g., a compression nut, a spanner nut, etc.) 320, which is implemented as a nut and herein referred to as the “nut 320,” and a key 322. In turn, the example key 322 includes a center portion (e.g., a concave center portion, a center opening portion, etc.) 323 having locking arms 325 extending therefrom. In some examples, the folding apparatus 300 includes at least one wave spring 324. In this example, the rotational hub/joint 311, which may be operatively coupled to and/or integral with the respective wing 310, includes a recess or channel (e.g., a slot, etc.) 326. By utilizing the channel 326, examples disclosed herein can reduce complexity of parts, which can typically entail disadvantageously expensive manufacturing processes. The channel 326 can also advantageously free up fuselage volume/space for additional equipment, payloads, etc.

According to examples disclosed herein, the wings 310 are rotationally coupled to the rotational joint 302 in a stack-up (e.g., a stack-up assembly, a stack-up configuration, etc.) by threadably coupling the fastener 319 to threads of the rotational joint 302 (e.g., a Heli-Coil® insert of the rotational joint 302). Accordingly, both of the wings 310 can be rotated with corresponding axes of rotation that are generally aligned and/or co-linear to one another. In other examples, the wings 310 rotate along axes of rotation that are spaced apart and/or offset from one another. According to examples disclosed herein, coupling the nut 320 to the rotational joint 302 with a threaded joint therebetween restrains the wings vertically (in the view of FIG. 3) and compression of the wave spring 324 applies a pre-load to the example stack-up of FIG. 3. Further, to enable relatively low friction movement of the wings 310, the sleeve bearings 308 facilitate movement of the wings 310 for rotation during deployment. While the wave spring 324 is implemented in this example, any other appropriate spring device/mechanism can be implemented instead.

In the illustrated example of FIG. 3, the example nut 320 is rotationally locked and/or constrained to the rotational joint 302 via the key 322. For example, the rotational joint 302 and/or the nut 320 includes anti-rotation features (e.g., channels, indents, grooves, etc.) that interface with the aforementioned key 322. In the illustrated example, the fastener 319 passes through an aperture (e.g., a central aperture, a concave aperture, etc.) of the central portion 323 of the key 322 while the arms 325 are received by (e.g., pressed into) grooves of the nut 320 to rotationally lock the key 322. In other words, the example key 322 can be at least partially received by a locking feature of the rotational joint 302 and/or the nut 320 to constrain the aforenoted stack-up, which can be particularly advantageous in aircraft applications that can be subject to wind forces, sudden acceleration/forces, etc.

In the illustrated example of FIG. 3, to deploy and/or unfold the wings 310, as generally indicated by arrows 332, each of the springs 314 urges the corresponding wing 310 to rotate away from the fuselage 202 when the aircraft 102 is released and/or launched from the host 101 shown in FIG. 1. In particular, the tail wings 310 can be passively unfolded via a spring force as the aircraft 102 is launched. In other words, the wings 310 can be deployed via passive activation. In this example, each of the springs 314 causes movement of the respective rotational joint/hub 311 and, in turn, the respective wing 310 via the eye 316 and the bushing 317. Further, a slotted shape of the recess 326 of the rotational joint/hub 311 enables the spring 314 to pivot and/or rotate relative to the wing 310 while conserving volume. According to examples disclosed herein, when the aircraft 102 is launched from the host 101, a release and/or removal of a constraint (e.g., a surface of the host 101 that contains the wing 310 prior to launch, etc.) and/or a locking device (e.g., a device/mechanism of the host 101 that moves away from the aircraft 102 during launch, etc.) enables the springs 314 to rotate the respective wings 310 about the rotational joint 302, thereby causing the wings 310 to unfold. In this example, both of the springs 314 are implemented as gas compression springs to advantageously provide a sufficient force, force impulse and/or force profile imparted to the wings 310 in a relatively short time frame. However, any other appropriate spring or force device can be implemented instead. In some examples, the fuselage 202 includes Delrin® inserts to absorb an impulse a result of rotating the wings 310. However, any other appropriate type of insert and/or insert material can be implemented instead.

As can be seen in this example, the wings 310 are deployed and/or folded away from the fuselage along opposite rotational directions (e.g., counter-rotational directions, etc.) from one another. In other examples, the wings 310 rotate along a same (or similar) rotational direction during deployment thereof. In some examples, the springs 314 each include a rod end for coupling the spring 314 to the fuselage 202. In some such examples, the rod end includes a through dowel along with a set screw for coupling the spring 314 to the fuselage 202.

In some examples, the fitting 304 is implemented as a relatively low profile threaded aluminum backup ring that is positioned on an interior volume of the fuselage 202 to minimize volume and simplify installation/manufacturing, thereby reducing manufacturing costs, labor costs, etc. According to examples disclosed herein, the fitting 304 is coupled (e.g., fastened, threadably coupled, etc.) to the rotational joint 302 (e.g., the fitting 304 is fastened and/or screwed to the rotational joint 302 via apertures or openings of the surface 301, etc.).

According to some examples disclosed herein, and as depicted in FIG. 3, wiring (e.g., control surface wiring, actuator wiring, etc.) 334 is routed from an aperture or opening of the rotational joint 302 to a longitudinal span of the wing 310 such that the wiring 334 traverses a longitudinal length of the spring 314. In this example, the wiring 334 is implemented without significantly impeding performance of the aircraft 102.

According to some examples disclosed herein, the rotational joint 302 includes a keying feature and/or spindle (e.g., a spindle aperture, a keyed feature, etc.) to interface and/or rotationally lock with the nut 320, the key 322 and/or the wings 310. In this example, the wings 310 are at least partially composed of carbon fiber reinforced polymer (CFRP) (e.g., foam core stiffened CFRP, etc.). However, any other appropriate polymer, polymer matrix, metal, material and/or metallic material can be implemented instead. In some examples, the recess 326 is molded into the wing 310 and/or defined in a process, such as machining, etching, material removal, etc. Additionally, or alternatively, the sleeve bearings 308 each include a groove or recess to receive at least a portion of the retainer 318, and are at least partially composed of a relatively low friction polymer, such as polytetrafluoroethylene (PTFE) (e.g., Rulon®). However, any other appropriate low friction polymer (or other material type) can be implemented instead.

According to some examples disclosed herein, to reduce friction and/or rotational resistance of the wings 310 (e.g., during deployment of the wing 310, during folding of the wings 310, etc.), at least one of the anti-friction shims 306 may be implemented. In some such examples, the anti-friction shim 306 includes and/or is at least partially composed of PTFE, stainless steel, etc. Additionally, or alternatively, the anti-friction shim 306 includes an adhesive side (e.g., a self-adhesive side, a one-sided adhesive, etc.). However, any other appropriate material, device, application (e.g., chemical application, lubricant application, adhesive application, etc.) and/or mechanism for reducing friction and/or rotational resistance can be implemented instead.

While the key 322 is implemented in this example, any other appropriate locking, keying and/or restraining mechanism can be implemented instead. In some examples, the key 322 and/or another key/locking mechanism device is utilized to restrain and/or maintain the wings 310 in their fully unfolded positions (e.g., subsequent to the deployment of the aircraft 102 from the host 101, etc.).

In some examples, the wings 310 each include a pivot stop feature and/or geometry to rotationally constrain a movement thereof. For example, the wings 310 each include interface surfaces 336 to contact a corresponding feature, mating contour and/or surface of the fuselage 202 to prevent further rotation of the wings 310 when the wings 310 are deployed (e.g., fully deployed). Additionally, or alternatively, the rotational joint 302 is at least partially composed of aluminum (e.g., machined aluminum, cast aluminum, etc.).

While two of the springs 314 are shown in this example, any appropriate number of springs (e.g., one, three, four, five, etc.) can be implemented instead. Further, any appropriate number of wings or wing bodies (e.g., four, six, etc.) can be implemented instead.

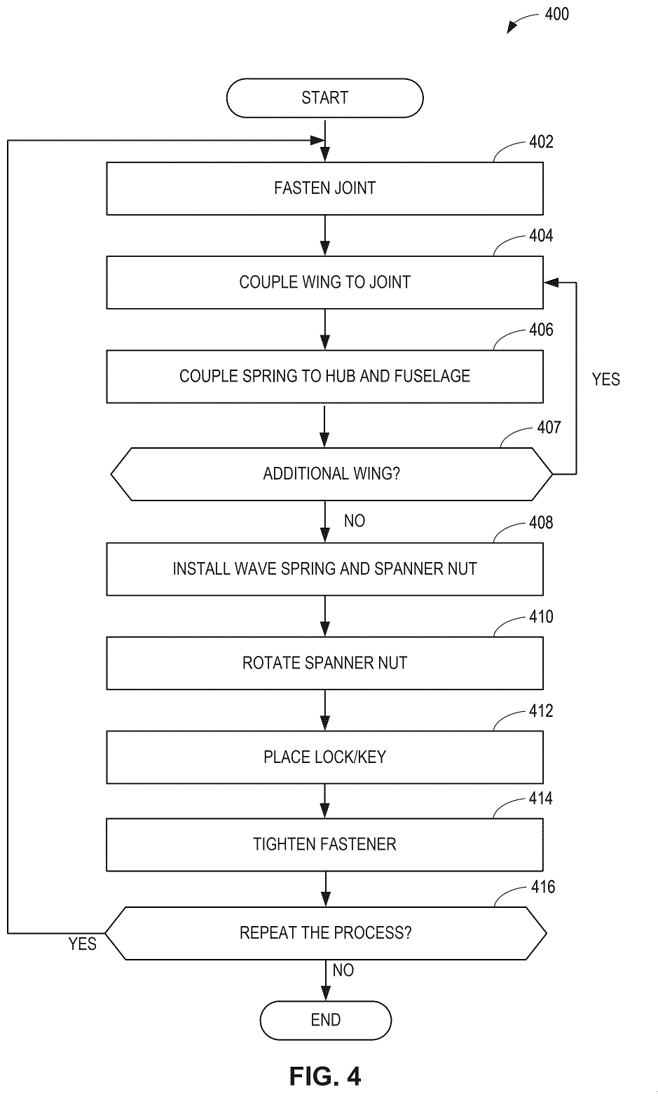

FIG. 4 is flowchart of an example method 400 to produce examples disclosed herein. In this example, the method 400 is implemented to produce, assemble, service and/or retrofit an ALE aircraft (e.g., the aircraft 102) with deployable wings that rapidly fold out from a fuselage in response to the aircraft being separated from a host (e.g., the host 101).

At block 402, according to some examples disclosed herein, a rotational joint is fastened and/or coupled to the fuselage. In this example, the rotational joint is fastened to the fuselage with a fitting that is positioned in an internal volume of the fuselage. In some such examples, the fasteners are utilized to secure and/or couple the fitting to the rotational joint.

At block 404, according to examples disclosed herein, the wing is coupled to the rotational joint of the fuselage of the aircraft.

At block 406, a spring is at least partially placed in a recess of a rotational hub of the respective wing, and operatively coupled between the rotational hub and the fuselage. In particular, the spring is pivotably/rotatably coupled to the rotational hub of the respective wing at a first end of the spring and pivotably/rotatably coupled to the fuselage at a second end of the spring that is opposite the first end. In this example, the spring is coupled to a slot of the rotational hub via a pin, and to the fuselage ground via a bolt. According to examples disclosed herein, a rotational travel of the wing is farther forward than in flight conditions due to a lack of a removable stop block of the fuselage. Accordingly, this removal of the block enables the fully extended spring to be installed to the wing, then compressed by rotating the wing after the pin couples the spring to the wing. Subsequently, in some examples, the stop block is installed to limit forward rotational travel of wing to a flight configuration.

In this example, the rotational hub is generally cylindrical in shape. In some examples, the rotational hub is centered on a rotational axis of the wing.

At block 407, it is determined whether an additional wing is to be assembled to the rotational joint. If an additional wing is to be assembled (block 407), control of the process returns to block 404. Otherwise, the process proceeds to block 408. In this example, two of the wings are aligned in a stack-up (e.g., a stacked assembly) and coupled to the rotational joint such that axes of rotations of the wings are aligned to one another, and further aligned to a center axis (e.g., a spindle center axis, etc.) of the rotational joint of the fuselage. In other examples, the wings are spaced apart and/or offset from one another. For example, at least two of the axes of rotations of the wings are offset from one another (e.g., the wings are placed on separate rotational joints of a fuselage).

At block 408, a spanner nut and (at least one) wave spring are assembled to the aforementioned stack-up. In this example, the wave spring and the spanner nut are installed on the rotational joint and into a molded pocket on the upper wing, for subsequent tightening to a calculated preload. Any appropriate type of spring device/mechanism/assembly can be implemented instead.

At block 410, in some examples, the spanner nut is rotated. In this example, the spanner nut is rotated to line up to a closest slot alignment of a plurality of slots.

At block 412, in some examples, a key and/or a lock is placed onto/into the aforementioned stack-up. In particular, the key and/or the lock can be placed in a corresponding slot to prevent rotation and/or loosening (e.g., backing out) of the nut and/or the fastener. In other words, the nut and/or the fastener can be prevented from backing out during motion of the aircraft (e.g., due to vibrational effects, etc.).

At block 414, a nut and/or a fastener is secured and/or threadably coupled to (e.g., threaded to, threaded on, etc.) the rotational joint and, as a result, the aforementioned stack-up of the wings is pushed against a load bearing and/or cushioning fuselage interface/surface (e.g., via a wave spring or other compression device, etc.). In this example, the nut and/or the fastener is torqued to a specified torque to push the rotational hubs of the wings against one another and the rotational joint of the fuselage. In some such examples, as mentioned above, one or more springs (e.g., wave springs, Belleville springs, etc.) are utilized to compress the stack-up and induce a pre-load thereto.

At block 416, it is determined whether to repeat the process. If the process is to be repeated (block 416), the process returns to block 402. Otherwise, the process ends. This determination may be based on whether additional wings and/or aircraft are to be assembled, produced. retrofitted, and/or serviced.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Example methods, apparatus, systems, and articles of manufacture to enable light weight and cost-effective deployment of ALE wings are disclosed herein. Further examples and combinations thereof include the following:
Example 1 includes an apparatus for deploying a wing for an aircraft, the apparatus comprising a rotational joint of a fuselage of the aircraft, a spring having a first end and a second end, and a hub defined by or operatively coupled to the wing, the hub operatively coupled to the first end of the spring, the second end of the spring operatively coupled to the fuselage, the spring to urge the wing to move relative to the fuselage when the aircraft is launched from a host.
Example 2 includes the apparatus as defined in example 1, wherein the hub includes a recess to receive at least a portion of the spring.
Example 3 includes the apparatus as defined in any of examples 1 or 2, further including a wave spring, the wave spring to be compressed with a fastener that is coupled to the rotational joint to secure the wing to the rotational joint.
Example 4 includes the apparatus as defined in any of examples 1 to 3, further including a key to rotationally lock a fastener that is threadably coupled to the rotational joint.
Example 5 includes the apparatus as defined in example 4, wherein at least one of the hub or the fastener includes a locking feature to receive at least a portion of the key.
Example 6 includes the apparatus as defined in any of examples 1 to 5, wherein the spring is a gas spring.
Example 7 includes the apparatus as defined in any of examples 1 to 6, wherein the wing is a first wing, and further including a second wing and a second spring, the second wing to be urged by the second spring to rotate in a direction opposite a direction of rotation of the first wing.
Example 8 includes a wing assembly for use with an aircraft, the wing assembly comprising a wing having a slot, a spring at least partially disposed in the slot, and a hub of the wing, the hub to be rotatably coupled to a rotational joint of a fuselage of the aircraft, the spring operatively coupled between the hub and the fuselage to urge the wing to rotate for deployment thereof.
Example 9 includes the wing assembly as defined in example 8, wherein the wing is a first wing and the spring is a first spring, and further including a second wing and a second spring, the second spring to urge the second wing to rotate.
Example 10 includes the wing assembly as defined in example 9, wherein the second spring is to urge the second wing to rotate in a direction opposite to that which the first spring urges the first wing to rotate when the first and second wings are being deployed.
Example 11 includes the wing assembly as defined in any of examples 9 or 10, wherein a first axis of rotation of the first wing is aligned to a second axis of rotation of the second wing.
Example 12 includes the wing assembly as defined in any of examples 8 to 11, further including a sleeve bearing between the wing and the rotational joint.
Example 13 includes the wing assembly as defined in any of examples 8 to 12, further including a spring to be compressed between the rotational joint and a fastener, the fastener threadably coupled to the rotational joint.
Example 14 includes the wing assembly as defined in any of examples 8 to 13, further including a key to be at least partially received by a locking feature of at least one of the rotational joint or a fastener threadably coupled to the rotational joint.
Example 15 includes the wing assembly as defined in any of examples 8 to 14, wherein the hub includes the slot.
Example 16 includes the wing assembly as defined in any of examples 8 to 15, further including a retainer between a fastener threadably coupled to the rotational joint and the rotational joint.
Example 17 includes a method of producing an aircraft with a deployable wing, the method comprising placing at least a portion of a spring in a recess of a hub of the wing, operatively coupling the hub of the wing to a rotational joint of a fuselage of the aircraft, and operatively coupling the spring between the hub and the fuselage to urge the wing to move relative to the fuselage when the aircraft is launched from a host.
Example 18 includes the method as defined in example 17, further including operatively coupling a fastener to the rotational joint to compress a wave spring against the wing.
Example 19 includes the method as defined in any of examples 17 or 18, wherein the wing is a first wing, and further including operatively coupling a second wing to the rotational joint, a first rotational axis of the first wing aligned to a second rotational axis of the second wing.
Example 20 includes the method as defined in any of examples 17 to 19, wherein operatively coupling the spring between the hub and the fuselage includes coupling the spring to the hub at the recess of the hub.

From the foregoing, it will be appreciated that example systems, apparatus, articles of manufacture, and methods have been disclosed that enable lightweight and cost-effective deployment of foldable structures, such as wings. Examples disclosed herein do not necessitate heavy and space-consuming actuators, servos, etc. Examples disclosed herein can reduce manufacturing cost, and assembly time while freeing up usable aircraft volume and/or storage for other systems and payloads. Examples disclosed herein can position a wing pivot significantly forward on an aircraft to enable a static wing design with sufficient span and chord to meet lift requirements without weight corresponding to typically necessitated augmentation features. Further, according to examples disclosed herein, wings can be stacked/assembled together on a single side or surface of an aircraft, thereby freeing up space/volume available for other uses.

According to examples disclosed herein, a rotational joint can include a spindle fitting that is at least partially composed of aluminum (e.g., machined aluminum, cast aluminum, etc.). In particular, the rotational joint locates and/or positions the wings relative to a fuselage and each of the wings to be stacked together (e.g., in a compressed stack-up, etc.). During deployment of the aircraft, the wings can counter-rotate against one another other to move into a flight configuration. In some examples, the rotational joint is attached to the fuselage by utilizing a single relatively low profile threaded aluminum backup ring on an interior space of the aircraft to reduce and/or minimize volume and simplify installation of the wings.

According to examples disclosed herein, relatively lightweight polymer bearings in conjunction with low-profile wave springs provide relatively low friction rotational surfaces and a preload for reacting to wing lift forces. In some examples, an assembly preload (e.g., a stack-up preload, etc.) can be accomplished via a spanner nut threaded onto the spindle and locked into position by a key that enables discrete adjustments.

According to examples disclosed herein, relatively low friction adhesive backed polymer rings between wing hubs/roots, and the lower wing/fuselage can reduce complexity, weight, and deployment drag, etc. Further, gas springs can advantageously extend from a fuselage to a wing hub/root via a dowel pin, for example, to reduce and/or minimize moving parts while enabling reliable wing deployment over multiple deployments thereof. Examples disclosed herein can utilize relatively few parts and correspond to a relatively small footprint, thereby increasing an amount of room available for a payload or other component/device to be carried.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus for deploying a wing for an aircraft, the apparatus comprising:
a rotational joint at a fuselage of the aircraft;
a spring having a first end and a second end;
a hub defined by or operatively coupled to the wing, the hub operatively coupled to the first end of the spring, the second end of the spring operatively coupled to the fuselage, the spring to urge the wing to move relative to the fuselage when the aircraft is launched from a host; and
a key to rotationally lock a fastener that is threadably coupled to the rotational joint via a nut, the nut having a plurality of radially arranged grooves to receive arms of the key, the radially arranged grooves angled from one another, the fastener to pass through the nut to be threadably coupled to the rotational joint.

2. The apparatus as defined in claim 1, wherein the hub includes a recess to receive at least a portion of the spring.

3. The apparatus as defined in claim 1, further including a wave spring, the wave spring to be compressed with the fastener.

4. (canceled)

5. The apparatus as defined in claim 1, wherein at least one of the hub or the nut includes a locking feature to receive at least a portion of the key.

6. The apparatus as defined in claim 1, wherein the spring is a gas spring.

7. The apparatus as defined in claim 1, wherein the wing is a first wing, and further including a second wing and a second spring, the second wing to be urged by the second spring to rotate in a direction opposite a direction of rotation of the first wing.

8. A wing assembly for use with an aircraft, the wing assembly comprising:
a wing having a slot;
a spring at least partially disposed in the slot;
a hub of the wing, the hub to be rotatably coupled to a rotational joint of a fuselage of the aircraft, the spring operatively coupled between the hub and the fuselage to urge the wing to rotate for deployment thereof; and
a key to rotationally lock a fastener that is threadably coupled to the rotational joint via a nut, the nut having a plurality of radially arranged grooves to receive arms of the key, the radially arranged grooves angled from one another, the fastener to pass through the nut to be threadably coupled to the rotational joint.

9. The wing assembly as defined in claim 8, wherein the wing is a first wing and the spring is a first spring, and further including a second wing and a second spring, the second spring to urge the second wing to rotate.

10. The wing assembly as defined in claim 9, wherein the second spring is to urge the second wing to rotate in a direction opposite to that which the first spring urges the first wing to rotate when the first and second wings are being deployed.

11. The wing assembly as defined in claim 9, wherein a first axis of rotation of the first wing is aligned to a second axis of rotation of the second wing.

12. The wing assembly as defined in claim 8, further including a sleeve bearing between the wing and the rotational joint.

13. The wing assembly as defined in claim 8, further including a spring to be compressed between the rotational joint and the fastener.

14. (canceled)

15. The wing assembly as defined in claim 8, wherein the hub includes the slot.

16. The wing assembly as defined in claim 8, further including a retainer between the fastener and the rotational joint.

17. A method of producing an aircraft with a deployable wing, the method comprising:
placing at least a portion of a spring in a recess of a hub of the wing;
operatively coupling the hub of the wing to a rotational joint of a fuselage of the aircraft; and
operatively coupling the spring between the hub and the fuselage to urge the wing to move relative to the fuselage when the aircraft is launched from a host; and
placing a key onto the rotational joint, the key to rotationally lock a fastener that is threadably coupled to the rotational joint via a nut, the nut having a plurality of radially arranged grooves to receive arms of the key, the radially arranged grooves angled from one another, the fastener to pass through the nut to be threadably coupled to the rotational joint.

18. The method as defined in claim 17, further including operatively coupling a fastener to the rotational joint to compress a wave spring against the wing.

19. The method as defined in claim 17, wherein the wing is a first wing, and further including operatively coupling a second wing to the rotational joint, a first rotational axis of the first wing aligned to a second rotational axis of the second wing.

20. The method as defined in claim 17, wherein operatively coupling the spring between the hub and the fuselage includes coupling the spring to the hub at the recess of the hub.

21. The apparatus as defined in claim 1, wherein the key includes a central portion from which the arms extend, the central portion including an aperture extending therethrough to receive at least a portion of the fastener when the fastener is threadably coupled to the rotational joint.

22. The apparatus as defined in claim 21, wherein the central portion includes a concave portion surrounding the aperture, the concave portion to receive an angled head of the fastener.
